(19) United States
(12) Patent Application Publication
(10) Pub. No.: US 2007/0107987 A1
(43) Pub. Date: May 17, 2007

(54) IMPROVED ADJUSTABLE LADDER SUPPORT

(76) Inventor: WILLIAM T. SMITH, CHAMBLEE, GA (US)

Correspondence Address: IP Authority, LLC;Ramraj Soundararajan, 9435 Lorton Market St. #801, Lorton, VA, 22079, US

(21) Appl. No.: 11/164,258

(22) Filed: Nov. 16, 2005

(51) Int. Cl. E06C 1/00; E06C 7/00

(52) U.S. Cl. 182/201

(57) ABSTRACT

An improved ladder support with a sliding clamp and rod arrangement for leveling a ladder comprises a base unit of a hollow rectangular shape adapted to securely hold the leg of the ladder. The base unit comprises two detachable outer members which have interior walls spaced apart sufficiently to accommodate the ladder leg when they are connected together. The interior wall on each of the outer members has formed thereon a plurality of spaced splices that slope outwardly and downwardly away from the ladder leg. The detachable outer members are removably secured together using corresponding hinge mechanisms and pins. A clamp member comprises a block that has formed thereon sloping splices that correspondingly fit into the grooves or spaces between the splices of the outer members that form the base unit. Clamp member has a bore that adjustably and securely retains a support rod, which has a swivel foot at one end. The end of the clamp member that is to be placed adjacent the ladder leg and the opposing interior surface of the base unit have a substantially angled configuration to insure slip free purchase against the ladder leg.

### CROSS-REFERENCE TO RELATED APPLICATIONS

This application is related to the application by Smith entitled “Adjustable Ladder Support”, now U.S. Pat. No. 6,745,870 B2, which is hereby cross-referenced in its entirety, including any appendices and references thereto.

### FIELD OF INVENTION

The present invention relates generally to the field of ladder attachments. More specifically, the present invention is related to improved removable and detachable ladder attachments to provide support for a ladder.

### DISCUSSION OF PRIOR ART

Ladders are used extensively in a number of different situations such as construction, painting, building maintenance, etc. At times, the surface a ladder needs to be placed on is uneven or inclined. Yet, placement of a ladder on an uneven surface renders the ladder unstable, which increases the possibility of the ladder toppling over, resulting in injury to workers. Therefore, a number of devices have been developed to adjust the level of the ladder legs so that the ladder is firmly supported, even when placed on uneven surfaces.

U.S. Pat. No. 3,447,631 (Smith), U.S. Pat. No. 4,412,599 (McCrudden et al.), U.S. Pat. No. 4,607,726 (Davis et al.), U.S. Pat. No. 4,792,017 (Grove), U.S. Pat. No. 5,551,529 (Molitor), and U.S. Pat. No. 5,678,656 (Lanzafame) describe prior devices and methods supporting ladder legs, but do not provide an adjustable support that is easily and removably secured (attached and detached) without the need for any tools. Further, they do no employ an attachment arrangement that acts to tighten the grip on the ladder during use to insure against slippage.

U.S. Pat. No. 6,745,870 B2, also assigned to the applicant, is an example of the prior art that provides for an adjustable ladder support comprising a base unit and clamping member, as illustrated in FIGS. 1-4. In the prior art the base unit has a channel 11 formed by web 44 and corresponding sidewalls 42 and 43. Channel 11 includes a plurality of spaced splices 16 and 17 and extending flanges 33 and 34 at its open end (see FIG. 1). The base unit also has a removable end cap 36 that attaches to the ends of sidewalls 42 and 43. End cap 36 has first and second flanges 37 and 38 which are designed to grip flanges 33 and 34 of channel 11 (see FIG. 2). To assemble, channel 11 is placed on ladder leg 12. Sliding clamp member 18 with support rod 26 with swivel foot 27 is placed against ladder leg 12, and the splices of the channel and clamp grip the ladder leg. End cap 36 is then mounted (see FIGS. 3 and 4).

The '870 design provides a removably secure ladder attachment that may be easily assembled. There is still a desire, however, for an improved adjustable ladder support that is easily connected and removably attached without the need for any tools that has a stronger, safer, and more user-friendly design.

### SUMMARY OF THE INVENTION

Generally, an improved ladder attachment that can be removably secured to a ladder leg is provided. The ladder attachment comprises a base unit and a clamping member. The base unit has a channel formed by a two detachable members which form an interior channel or web when connected, and have corresponding sidewalls substantially perpendicular to the formed web. The sidewalls are sufficiently spaced apart to accommodate the ladder leg and the interior surface of each member has a sidewall with sloping splices formed thereon. The clamping member is generally rectangular and has sloping splices formed on its first and second side surfaces. The sloping splices on the clamping member are dimensioned and arranged so as to slidably engage with the sloping splices on the sidewalls of each member. The clamping member also has a bore to adjustably and securely retain a support rod therein. The sloping splices on the clamping member and the sloping splices on the sidewalls are arranged such that, during use, the clamping member is biased towards the ladder leg.

The clamp member has a bore that adjustably and securely retains a support rod, which has a swivel foot at one end. The end of the clamp member that is to be placed adjacent the ladder leg and the opposing interior surface of the base unit have a substantially angled configuration to insure slip free purchase against the ladder leg.

### BRIEF DESCRIPTION OF THE DRAWINGS

FIG. 1 illustrates the prior art channel of a ladder attachment's base unit.

FIG. 2 illustrates the prior art end cap of a ladder attachment's base unit.

FIG. 3 illustrates the prior art assembly procedure for a ladder attachment.

FIG. 4 illustrates the prior art assembled ladder attachment.

FIG. 5 illustrates the preferred embodiment of the ladder support's base unit.

FIGS. 6 and 7 illustrate the assembly procedure for the ladder support.

FIG. 8 illustrates an overhead view of the assembled ladder support.

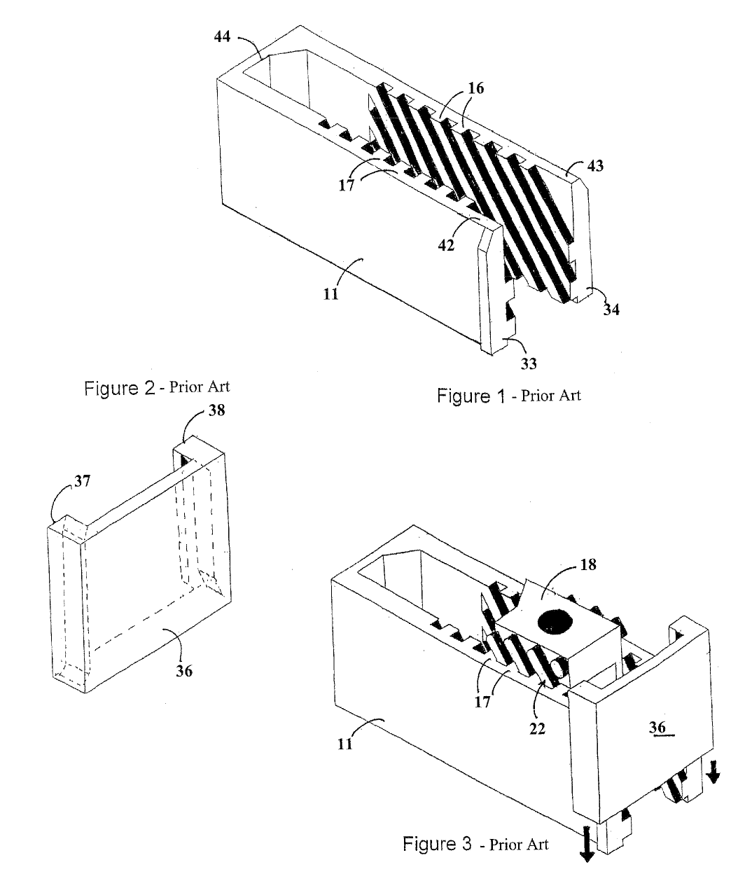

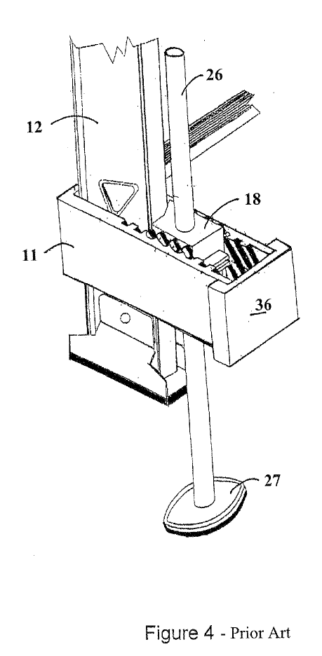

### DESCRIPTION OF THE PREFERRED EMBODIMENTS

While this invention is illustrated and described in a preferred embodiment, the device may be produced in many different configurations, forms and materials. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

It is envisioned that the ladder attachment of the present invention is used primarily as a ladder leveler. Other uses, however, are possible. For instance, it may also be used at the top of the ladder in an upside down position for holding ladder stand-offs. Various other variations will also occur to workers in the art without departure from the scope of the invention.

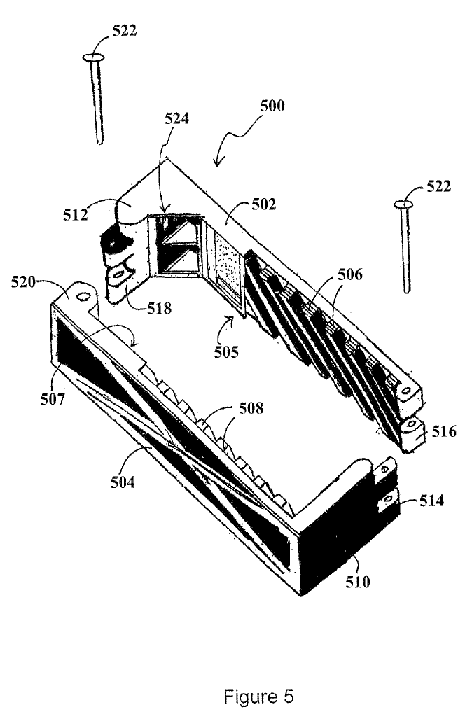

FIG. 5 illustrates the preferred embodiment of the improved ladder attachment's or ladder support's base unit. Base unit 500 comprises two detachable outer members 502 and 504. Outer members 502 and 504 are designed to be assembled or connected to each other such that an interior channel or web is formed therebetween to accommodate a ladder leg, as will be described later. Outer members 502 and 504 may be made of metal, high strength plastic, wood, or other suitable material. Outer member 502 has an elongated sidewall with interior surface 505 with a plurality of spaced splices 506 formed thereon, which slope in a direction downward from the top. Outer member 504 also has an elongated sidewall with an interior surface 507 with a plurality of sloped, spaced splices 508. Detachable members 502 and 504 are preferably connected via hinge joint. Member 502 also has one extending end 512 with hinge connection 518 and angled edge 524, and an opposite end with hinge connection 516. Member 504 has extending end 510 with hinge connection 514, and an opposite end with hinge connection 520. Hinge connections 516 and 518 of outer member 502 are provided to connect to corresponding hinge connections 514 and 520 of outer member 504 to form an interior channel. The hinge connections are preferably connected together via pins 522; however, any suitable connection device would be within the scope of the invention. Furthermore, although a hinge joint is the preferred connection method, any method of attaching and removably securing the two detachable outer members is within the scope of this invention. Angled edge 524 is designed to be positioned against a ladder leg to thus provide support (as will be further described below). Angled edge 524 may be provided on either outer member 502 or 504.

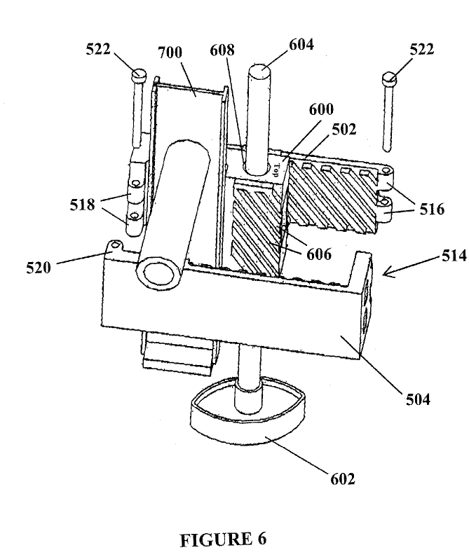

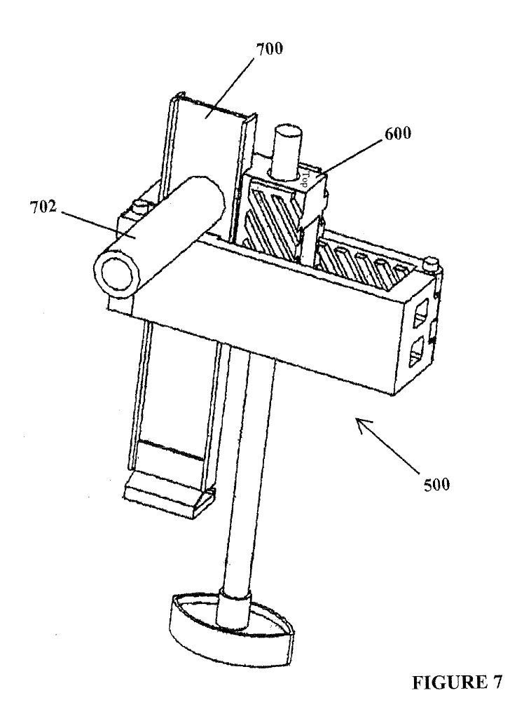

FIGS. 6 and 7 illustrate the assembly procedure for the ladder support. Clamp member 600 comprises a block of metal, high strength plastic, wood, or other suitable material. Clamp member 600 is preferably of rectangular shape. Also formed on either side surface of clamp member 600 are sloping splices 606. The width and height of each of the splices 606 is such that they fit into the grooves or spaces between splices 506 and 508 formed on outer members 502 and 504. Clamp member also has bore 608 extending therethrough to accommodate support rod 604, which has swivel foot 602 at one end. Support rod is held in place with clamp member 600 and a suitable clamping means (not shown). The clamping means may take many forms, e.g., wedges, bolts, etc. and must be capable of holding rod 604 firmly in place within member 600 without slippage.

Outer members 502 and 504 are designed to be secured such that they form a channel for ladder leg 700 to be held within. Hinge connections 514, 516, 518, and 520 are easily connected together by sliding pins 522 into the aligned holes (as shown in FIGS. 5, 6, and 7) on each end of members 502 and 504. Outer members 502 and 504 are positioned or placed on ladder leg 700, and sliding clamp member 600 is then positioned at the desired location, preferably just below a ladder rung 702. Splices 506 and 508 are positioned and slid onto clamp member 600, with their respective splices and grooves meshing. As shown in FIGS. 6 and 7, corresponding hinge connections 516 and 514 and 518 and 520 are interlocked using pins 522. Splices 506 and 508 on outer members 502 and 504 are then able to grip splices 606 of clamp member 600, thus allowing for a tight grip on ladder leg 700.

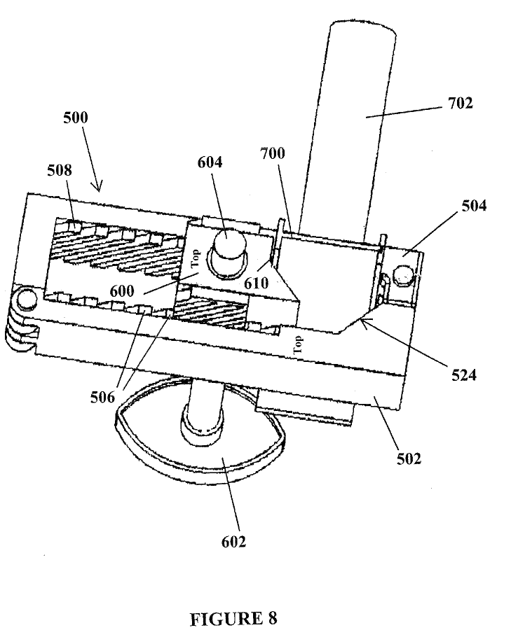

Also, as shown in FIG. 8, clamping member 600 has one end that is to be placed adjacent ladder leg 700 which has a substantially V-shaped or double-angled edge configuration 610 to insure a slip free surface against ladder leg 700 by bearing against the leg and at least one edge of a leg rail or flange. Angled edge 524 on interior surface 505 of outer member 502 is also provided against ladder leg 700 to insure a slip-free surface.

In use, the forces on the ladder and the adjustable support act to tighten the grip of the channel formed by outer members 502 and 504 and clamp member 600 on ladder leg 700, thereby insuring against slippage. Clamp member 600 experiences an upward force from rod 604, while members 502 and 504 experience a downward force from ladder leg 700. This tends to cause clamp member 600 to move slightly upward relative to outer members 502 and 504. Because of the sloping splices, clamp member 600 is biased towards ladder leg 700 when it moves upward. Therefore, the slight upward movement caused by the forces act to bias the clamp member towards ladder leg 700, thereby tightening the grip of the outer members and clamp member on the ladder leg. Ladder leg 700 is held forcibly and tightly against angled edge 524 of outer member 502 to securely support the ladder upon placement on an uneven surface, thus acting as a “ladder leveler.” Support rod 604 may then be adjusted in bore 608 to produce the desired leg extension and locked in place. Thus, as can be seen, no tools of any sort are required to assemble and use the adjustable ladder support according to the invention. The ladder attachment is also capable of being easily connected and removably secured to a ladder leg through the above-described detachable outer members. Furthermore, the design and assembly provide a stronger, safer, and more user-friendly attachment device for extending or adjusting the level of a ladder leg.

The foregoing is considered illustrative only of the principles of the invention. Therefore, it will be understood that there is no intent to limit the invention by such disclosure, but rather, it is intended to cover all modifications and alternate constructions falling within the spirit and scope of the invention. For example, while base unit 500 formed of two outer members 502 and 504 has been illustrated, the present invention is not limited thereto to a specific number of pieces. As another alternative, a nut and bolt arrangement, or other screw-type mechanism, can be used in place of pins to provide the connection of the adjustable, substantially inward compressive force as provided by the detachable outer members 502 and 504.

### CONCLUSION

A system and method has been shown in the above embodiments for the effective implementation of an improved adjustable ladder support. While various preferred embodiments have been shown and described, it will be understood that there is no intent to limit the invention by such disclosure, but rather, it is intended to cover all modifications and alternate constructions falling within the spirit and scope of the invention, as defined in the appended claims. For example, the present invention should not be limited by size, form, materials, or specific manufacturing techniques. Also, the connection of the detachable outer members may include alternate methods that allow for easier assembling and disassembling of the ladder support and should not be limited to hinge mechanisms.

What is claimed is:

1. A ladder attachment that is removably secured to a ladder leg to provide leveling comprising:
a base unit comprising two detachable outer members, each outer member comprising an elongated sidewall and an extending end, said elongated sidewall of each outer member comprising an interior surface, the interior surface of each sidewall having sloping splices formed thereon;
a channel formed by the connection of said two outer members such that the sidewalls are sufficiently spaced apart to accommodate the ladder leg;
a clamping member having:
sloping splices formed on first and second side surfaces of the clamping member, the sloping splices on the clamping member dimensioned and arranged so as to slidably engage with the sloping splices on the sidewalls of said outer members; and
a bore adjustably and securely retaining a support rod therein;
said sloping splices on the clamping member and the sloping splices on the sidewalls are arranged such that, during use, the clamping member is biased towards said channel to clamp the ladder leg; and
wherein said ladder attachment enables leveling of said ladder by selective engagement of said sloping splices of said clamping member with said channel sidewalls at a specific point on said ladder leg.

2. A ladder attachment that is removably secured to a ladder leg, as per claim 1, wherein the bore extends through the clamping member from the top surface thereof.

3. A ladder attachment that is removably secured to a ladder leg, as per claim 1, wherein the support rod has a swivel foot attached at one end.

4. A ladder attachment that is removably secured to a ladder leg, as per claim 1, wherein the splices on the sidewalls slope in a downward direction from the top of the channel and the splices on the side surfaces of the clamping member slope in substantially the same direction as the splices on the sidewalls.

5. A ladder attachment that is removably secured to a ladder leg, as per claim 1, wherein the interior surface of the channel has a substantially angled configuration to be positioned against the ladder leg, formed by at least one of the detachable members having an angled edge on its sidewall.

6. A ladder attachment that is removably secured to a ladder leg, as per claim 1, wherein an end of the clamping member has a substantially V-shaped configuration.

7. A ladder attachment that is removably secured to a ladder leg, as per claim 1, wherein each of said detachable outer members comprise a hinge connection, said hinge connection of one of said outer members corresponding to said hinge connection of the second outer member to hold said outer members together via a hinge joint to form said channel.

8. A ladder attachment that is removably secured to a ladder leg, as per claim 7, wherein said hinge connections are connected via pins thus detachably securing said hinge joint.

9. A removable ladder leveler that is removably attached to a ladder leg comprising:
a base unit comprising two detachable outer members, each outer member comprising an elongated sidewall and an extending end, said elongated sidewall of each outer member comprising an interior surface, the interior surface of each sidewall having sloping splices formed thereon;
a channel formed by the connection of said two outer members such that the sidewalls are sufficiently spaced apart to accommodate the ladder leg;
a clamping member having:
sloping splices formed on first and second side surfaces of the clamping member, the splices sloping in substantially the same direction as the splices on the sidewalls and dimensioned so as to slidably engage with the splices on the sidewalls;
a bore extending through the clamping member from the top surface thereof;
a support rod adjustably and securely retained in said bore, the support rod having a foot attached at one end for contacting an external surface; and
wherein, during use, the splices on the clamping member and the splices on the interior surface of the sidewalls are arranged to bias the clamping member towards the ladder leg.

10. A removable ladder leveler that is removably attached to a ladder leg, as per claim 9, wherein the foot is a swivel foot.

11. A removable ladder leveler that is removably attached to a ladder leg, as per claim 9, wherein the interior surface of the channel has a substantially angled configuration to be positioned against the ladder leg, formed by at least one of the detachable members having an angled edge on it sidewall.

12. A removable ladder leveler that is removably attached to a ladder leg, as per claim 9, wherein an end of the clamping member has a substantially V-shaped configuration.

13. A removable ladder leveler that is removably attached to a ladder leg, as per claim 9, wherein said ladder attachment enables leveling of said ladder by selective engagement of said sloping splices of said clamping member with said channel sidewalls at a specific point on said ladder leg.

14. A removable ladder leveler that is removably secured to a ladder leg, as per claim 9, wherein each of said outer members comprise hinge connections, said hinge connection of one of said outer members corresponding to said hinge connection of the second outer member to hold said outer members together via a hinge joint to form said channel.

15. A removable ladder leveler that can be removably secured to a ladder leg, as per claim 9, wherein said hinge connections are connected via pins thus detachably securing said hinge joint.

16. An improved ladder attachment that is removably secured to a ladder leg to provide leveling comprising a base unit, a clamping member for slidably and correspondingly engaging said base unit, and a bore provided within said clamping member having a support rod, for biasing the clamping member towards the end of said interior channel to clamp and level the ladder leg, wherein the improvement comprises:
said base unit comprises two detachable outer members, each outer member comprising an elongated sidewall and an extending end, said elongated sidewall of each outer member comprising an interior surface, and said detachable outer members are connected to form a channel such that the sidewalls are sufficiently spaced apart to accommodate the ladder leg and clamping member.

17. An improved ladder attachment that is removably secured to a ladder leg, as per claim 16, wherein the support rod has a swivel foot attached at one end.

18. An improved ladder attachment that is removably secured to a ladder leg, as per claim 16, wherein the sidewalls of said outer members and side surfaces of said clamping member comprise corresponding splices that slope in a substantially downward direction.

19. An improved ladder attachment that is removably secured to a ladder leg, as per claim 16, wherein the interior surface of the channel has a substantially angled configuration to be positioned against the ladder leg, formed by at least one of the detachable members having an angled edge on its sidewall.

20. An improved ladder attachment that is removably secured to a ladder leg, as per claim 16, wherein an end of the clamping member has a substantially V-shaped configuration.

21. An improved ladder attachment that is removably secured to a ladder leg, as per claim 16, wherein each of said detachable outer members comprise a hinge connection, and said hinge connection of one of said outer members corresponds to said hinge connection of the second outer member to connect said outer members together via a hinge joint to form said channel.

22. An improved ladder attachment that is removably secured to a ladder leg, as per claim 21, wherein said hinge connections are connected via pins thus detachably securing said hinge joint.
